(19) United States
(12) Patent Application Publication
(10) Pub. No.: US 2023/0104267 A1
(43) Pub. Date: Apr. 6, 2023

(54) METHOD AND UE FOR DISCONTINUOUS RECEPTION (DRX) OPERATION FOR MBS IN WIRELESS NETWORK

(71) Applicant: Samsung Electronics Co., Ltd., Gyeonggi-do (KR)

(72) Inventors: Vinay Kumar SHRIVASTAVA, Bangalore (IN); Sangkyu BAEK, Gyeonggi-do (KR)

(21) Appl. No.: 17/959,843

(22) Filed: Oct. 4, 2022

(30) Foreign Application Priority Data
Oct. 4, 2021 (IN) 202141045022
Apr. 25, 2022 (IN) 202241024323
Sep. 9, 2022 (IN) 202141045022

(51) Int. Cl. H04L 1/18; H04W 76/28

(52) U.S. Cl. CPC H04L 1/1854; H04W 76/28; H04L 1/1822; H04L 1/1812

(57) ABSTRACT

The disclosure relates to a 5G or 6G communication system for supporting a higher data transmission rate. A method performed by a terminal in a wireless communication system includes receiving a medium access control (MAC) protocol data unit (PDU) for a unicast; starting a hybrid automatic repeat request (HARQ) round trip time (RTT) timer for the unicast in a first symbol after an end of a transmission carrying a HARQ feedback for a HARQ process corresponding to a downlink (DL) assignment; stopping a retransmission timer for the unicast for the HARQ process corresponding to the DL assignment; and stopping a retransmission timer for a multicast for the HARQ process corresponding to the DL assignment.

### CROSS-REFERENCE TO RELATED APPLICATION

This application is based on and claims priority under 35 U.S.C. § 119 to Indian Provisional Application Nos. 202141045022 and 202241024323, which were filed on Oct. 4, 2021 and Apr. 25, 2022, respectively, and to Indian Patent Application No. 202141045022, which was filed on Sep. 9, 2022, the entire content of each of which is incorporated herein by reference.

### BACKGROUND

### 1. Field

The disclosure relates to a wireless communication network, and in particular, to a method and a user equipment (UE) for a discontinuous reception (DRX) operation for new radio (NR) multicast broadcast service (MBS) in the wireless communication network.

### 2. Description of Related Art

5^{th} generation (5G) mobile communication technologies define broad frequency bands such that high transmission rates and new services are possible, and can be implemented in “sub 6 GHz” bands such as 3.5 GHz, and also in “above 6 GHz” bands (also referred to as mmWave) including 28 GHz and 39 GHz. In addition, 6G mobile communication technologies (also referred to as beyond 5G systems) have been considered for implementation in terahertz bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for larger data transmissions and a polar code for highly reliable transmissions of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, NR-unlicensed (NR-U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, it is expected that the number of connected devices that will be connected to communication networks will exponentially increase, and it is accordingly expected that enhanced functions and performances of 5G mobile communication systems and integrated operations of these connected devices will be necessary. To this end, new research is being performed in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Further, such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

In accordance with an aspect of the disclosure, a method is provided for a terminal in a wireless communication system. The method includes receiving a medium access control (MAC) protocol data unit (PDU) for a unicast; starting a hybrid automatic repeat request (HARQ) round trip time (RTT) timer for the unicast in a first symbol after an end of a transmission carrying a HARQ feedback for a HARQ process corresponding to a downlink (DL) assignment; stopping a first retransmission timer for the unicast for the HARQ process corresponding to the DL assignment; and stopping a second retransmission timer for a multicast for the HARQ process corresponding to the DL assignment.

In accordance with another aspect of the disclosure, a terminal is provided for use in a wireless communication system. The terminal includes a transceiver; and a processor coupled with the transceiver and configured to receive a MAC PDU for a unicast, start a HARQ RTT timer for the unicast in a first symbol after an end of a transmission carrying a HARQ feedback for a HARQ process corresponding to a DL assignment, stop a first retransmission timer for the unicast for the HARQ process corresponding to the DL assignment, and stop a second retransmission timer for a multicast for the HARQ process corresponding to the DL assignment.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates point-to-multipoint (PTM) transmission and PTM retransmission in an MBS, according to an embodiment;

FIG. 2 illustrates PTM transmission and point-to-point (PTP) retransmission in an MBS, according to an embodiment;

FIG. 3 illustrates MBS semi-persistent scheduling (SPS) and retransmissions in an MBS, according to an embodiment;

FIG. 4 illustrates a UE, according to an embodiment.

FIG. 5 is a flow chart illustrating a physical downlink control channel (PDCCH) monitoring and DRX timer operation, according to an embodiment;

FIG. 6 is a flow chart illustrating a PDCCH monitoring and DRX timer operation, according to an embodiment;

FIG. 7 is a flow chart illustrating a method for receiving a MAC PDU in a configured downlink assignment during a unicast DRX procedure, according to an embodiment;

FIG. 8 is a flow chart illustrating a method for receiving a PDCCH indicating a downlink transmission during a unicast DRX procedure, according to an embodiment;

FIG. 9 is a flow chart illustrating a method for a DRX operation for an MBS in a wireless network, according to an embodiment;

FIG. 10 illustrates a UE according to an embodiment; and

FIG. 11 illustrates a base station according to an embodiment.

### DETAILED DESCRIPTION OF INVENTION

Various embodiments of the disclosure will now be described with reference to accompanying drawings. In the drawings, like elements may be denoted by like reference numerals. Additionally, detailed descriptions of functions and features known to one of skill in the art are omitted to avoid obscuring the gist of the disclosure.

However, before undertaking the description below, it may be advantageous to set forth definitions of certain words and phrases used throughout this disclosure. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, etc. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The various embodiments described herein are not necessarily mutually exclusive, as some embodiments can be combined with one or more other embodiments to form new embodiments. Additionally, the examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is common, embodiments may be described and illustrated in terms of blocks which carry out a described function or functions. These blocks, which may be referred to herein as managers, units, modules, hardware components, etc., are physically implemented by analog and/or digital circuits such as logic gates, integrated circuits, microprocessors, microcontrollers, memory circuits, passive electronic components, active electronic components, optical components, hardwired circuits, etc., and may optionally be driven by firmware and software. The circuits may, for example, be embodied in one or more semiconductor chips, or on substrate supports such as printed circuit boards, etc. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In wireless communication networks, NR MBS services can refer to multicast services in which intended common contents are targeted to a group of UEs that have joined a multicast group in a multicast coverage area. Additionally, broadcast services provide intended contents to all the UEs in a broadcast coverage area. These coverage areas can be one cell or larger.

Two delivery methods are envisioned for 5G MBS services, from the view point of a 5G core network (CN): 1) an individual MBS traffic delivery method, and 2) a shared MBS traffic delivery method. For the former, the CN receives a single copy of MBS data packets and delivers separate copies of those MBS data packets to individual UEs via per-UE PDU sessions, while for the latter, the 5G CN receives a single copy of MBS data packets and delivers a single copy of those MBS packets packet to a radio access node (RAN), which then delivers them to one or multiple UEs. The RAN delivers MBS data to UEs using either PTP delivery or PTM delivery. The PTP is data transmission to a single target UE in an MBS. The PTM is data transmission to multiple target UEs in the MBS.

Further, at the UE, an MBS bearer may include a common protocol data convergence protocol (PDCP) entity with PTP, PTM, or a combination of PTP and PTM legs or RLC entities (also referred to as an MBS split bearer).

In cellular communication, unicast is traditional data transmission from single source to single target. For the purpose of power saving and efficient scheduling, unicast reception is associated with a unicast DRX approach. Further, there is a need for a DRX approach for reception of MBS services on PTM and PTP paths. Unlike long term evolution (LTE) evolved multimedia broadcast and multicast services (eMBMS), which support primarily broadcast services, NR MBS is targeted to support multicast services that require higher reliability, e.g., hybrid automatic repeat request (HARQ) retransmissions, to ensure recovery of packet loss over channel.

In accordance with an embodiment, a method is provided for DRX operation for an MBS in a wireless network. The method includes detecting, by a MAC entity of a UE in the wireless network, that a DRX operation is configured for unicast and PTM, wherein a unicast DRX configuration includes at least one of a unicast downlink (DL) drx-HARQ round trip time (RTT) timer or a unicast DL drx-Retransmission timer, and a PTM DRX configuration includes at least one of a PTM drx-HARQ RTT timer or a PTM drx-Retransmission timer. Further, the method includes receiving, by the MAC entity of the UE, a MAC PDU in a configured DL assignment for unicast. Further, the method includes starting, by the MAC entity of the UE, the unicast DL drx-HARQ RTT timer for the corresponding HARQ process in a first symbol after an end of the corresponding transmission carrying the DL HARQ feedback, in response to receiving the MAC PDU in the configured DL assignment for unicast. Further, the method includes detecting, by the MAC entity of the UE, that the unicast DL drx-Retransmission timer and the PTM drx-Retransmission timer are running. Further, the method includes stopping, by the MAC entity of the UE, both the unicast DL drx-Retransmission timer for the corresponding HARQ process and the PTM drx-Retransmission timer for the corresponding HARQ process based on the detection.

In accordance with another embodiment, a method is provided for DRX operation for an MBS in a wireless network. The method includes detecting, by the MAC entity of the UE, that a DRX group of the DRX operation is in an Active Time. Further, the method includes monitoring, by the MAC entity of the UE, a PDCCH on the serving cells in the DRX group. Further, the method includes receiving, by MAC entity of the UE, the PDCCH indicating a DL transmission for unicast. Further, the method includes starting or restarting, by the MAC entity of the UE, the unicast DL drx-HARQ RTT timer for the corresponding HARQ process or processes whose HARQ feedback is reported in the first symbol after the end of the corresponding transmission carrying the DL HARQ feedback in response to receiving PDCCH indicating a DL transmission for unicast. Further, the method includes detecting, by the MAC entity of the UE, that the unicast DL drx-Retransmission Timer and the PTM dry-Retransmission Timer are running. Further, the method includes stopping, by the MAC entity of the UE, both the unicast DL drx-Retransmission Timer for the corresponding HARQ process or processes whose HARQ feedback is reported and the PTM drx-Retransmission Timer for the corresponding HARQ process based on the detection.

There is also a requirement for a DRX approach for an MBS in order to support power efficient and reliable delivery of 5G MBS services. Further, the mechanisms should work for a PTM bearer, a PTP bearer, and an MBS split bearer based delivery framework for the NR MBS.

Therefore, in accordance with an embodiment, a method is provided to address the issues of DRX operations for MBS. In accordance with an embodiment, a discontinuous DRX is updated to specify that if a MAC PDU is received in a configured DL assignment for unicast, the MAC entity of the UE stops the PTM drx-Retransmission timer (also referred to as dry-RetransmissionTimerDL-PTM) for the corresponding HARQ process. Further, the method specifies that if the PDCCH indicates a DL transmission, the MAC entity of the UE stops the drx-RetransmissionTimerDL-PTM for the corresponding HARQ process. Thus, the method provides enhanced DRX operations to support NR MBS, improving a user experience with enhanced power performance of the UE.

In accordance with another embodiment, a method and a UE are provided for DRX operation for an NR MBS in a wireless network. In the method, a discontinuous DRX is updated to specify that if the MAC PDU is received in a configured downlink assignment for unicast, the MAC entity of the UE stops the PTM drx-Retransmission timer (i.e. drx-RetransmissionTimerDL-PTM) for the corresponding HARQ process. Further, the method specifies that if the PDCCH indicates a DL transmission for unicast, the MAC entity of the UE stops the drx-RetransmissionTimerDL-PTM for the corresponding HARQ process.

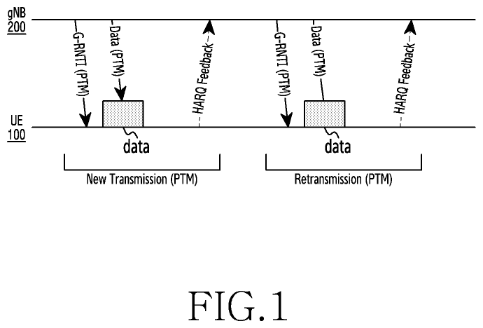

FIG. 1 illustrates PTM transmission and PTM retransmission in an MBS, according to an embodiment.

Referring to the FIG. 1, a new (or initial) HARQ transmission and a HARQ retransmission employ a PTM path. More specifically, a MAC entity at a UE 100 monitors a group common PDCCH (GC-PDCCH) on serving cells in a DRX group by using a group-radio network temporary identifier (G-RNTI) for the PTM transmission. The UE 100 provides HARQ feedback based on the decoding status of the received HARQ transmission (e.g., an acknowledgement (ACK) for successful decode or a negative ACK (NACK) for an unsuccessful decoding of the downlink HARQ packet or a transport block (TB)).

It is noted that the HARQ feedback is optional. Some UEs 100 may not have HARQ feedback, but may be able to receive retransmission data. Further, HARQ feedback can be configured, enabled, disabled, and de-configured by the network entity (e.g., a gNB 200). Accordingly, the UE 100 may apply or not apply HARQ feedback operations.

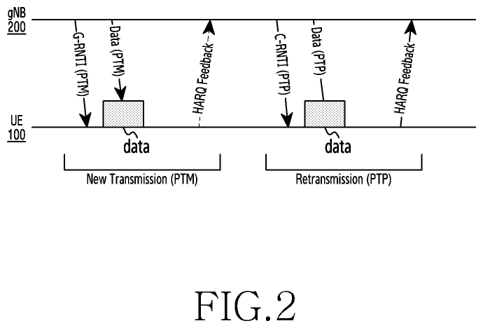

FIG. 2 illustrates PTM transmission and PTP retransmission in an MBS, according to an embodiment.

Referring to the FIG. 2 a new or initial HARQ transmission utilizes a PTM path and a HARQ retransmissions utilizes a PTP path.

In case that the UE 100 does have sufficient link quality for PTM reception with certain required service level, the gNB 200 may perform a retransmission by the PTP, where the UE 100 receives retransmission data by using a dedicated resource. Downlink control information (DCI) on a PDCCH addressed by a C-RNTI indicates whether the transmission is a PTP retransmission for PTM initial transmission.

FIG, 3 illustrates an MBS SPS and retransmissions in an MBS, according to an embodiment.

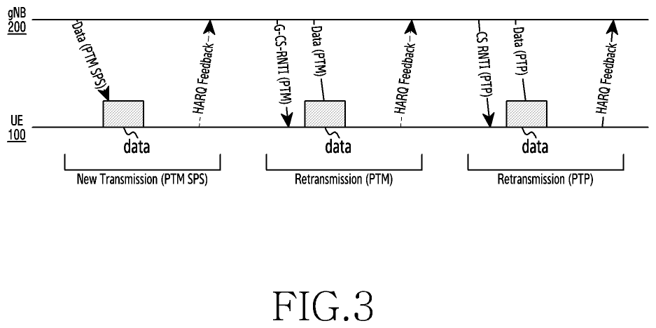

Referring to the FIG. 3, the PTM transmission can be performed in SPS, wherein the UE 100 receives data at pre-defined time with periodicity. The SPS, which is used for PTM transmission, may be referred to as PTM SPS or MBS SPS. The periodic SPS resource is used for initial transmission, i.e., a new transmission, whereas retransmission of an PTM SPS can be performed by using a G-CS-RNTI in a PTM manner or a CS-RNTI in a PTP manner. DCI on a PDCCH addressed by a G-CS-RNTI indicates whether the transmission is a PTM retransmission for a PTM initial transmission. The DCI on a PDCCH addressed by a CS-RNTI indicates whether the transmission is a PTP retransmission for a PTM initial transmission.

The MAC entity monitors the PDCCH by a C-RNTI and a CS-RNTI on the serving cells.

Since the UE power saving is an important issue in mobile communication, the DRX can be configured for the MBS. The MBS can have a dedicated DRX configuration called MBS DRX. The RRC controls a multicast DRX operation for PTP and/or unicast addressed by a C-RNTI or a CS-RNTI by configuring the following parameters—

drx-onDurationTimer: a duration at a beginning of a DRX cycle;

drx-SlotOffset: a delay before starting the drx-onDurationTimer;

drx-InactivityTimer: a duration after a PDCCH occasion in which a PDCCH indicates a new uplink (UL) or DL transmission for a MAC entity;

drx-RetransmissionTimerDL (per DL HARQ process except for a broadcast process): a maximum duration until a DL retransmission is received;

drx-LongCycleStartOffset: a long DRX cycle and a drx-StartOffset that defines a subframe in which the long and short DRX cycle starts;

drx-ShortCycle (optional): a Short DRX cycle;

drx-ShortCycleTimer (optional): a duration for which a UE shall follow a short DRX cycle; and

drx-HARQ-RTT-TimerDL (per DL HARQ process except for a broadcast process): a minimum duration before a DL assignment for HARQ retransmission is expected by a MAC entity.

The RRC controls multicast DRX operation for PTM per a G-RNTI or per a G-CS-RNTI by configuring the following parameters:

drx-onDurationTimerPTM: a duration at a beginning of a DRX cycle;

dix-SlotOffsetPTM: a delay before starting the drx-onDurationTimerPTM;

drx-InactivityTimerPTM: a duration after a PDCCH occasion in which a PDCCH indicates a new DL multicast transmission for a MAC entity;

drx-LongCycleStartOffsetPTM: a long DRX cycle and drx-StartOffsetPTM which defines a subframe where a long DRX cycle starts;

drx-RetransmissionTimerDL-PTM (per a DL HARQ process for multicast MBS): a maximum duration until a DL multicast retransmission is received; and

drx-HARQ-RTT-TimerDL-PTM (per a DL HARQ process for multicast MBS): a minimum duration before a DL multicast assignment for a HARQ retransmission is expected by a MAC entity.

Herein, the Active Time is a time period during which a MAC entity monitors a set of allocated RNTIs. Different types of Active Times for DRX operations are provided. Types of Active Times are used for different purpose.

Type 1 Active Time: MAC entity monitors a PDCCH addressed by at least one of a C-RNTI or a CS-RNTI on serving cells in this DRX group for unicast data reception

Type 2 Active Time: MAC entity monitors a GC-PDCCH addressed by at least one of a G-RNTI or a G-CS-RNTI on serving cells in this DRX group for PTM data reception

Type 3 Active Time: MAC entity monitors a GC-PDCCH addressed by at least one of a G-RNTI or a G-CS-RNTI on serving cells in this DRX group for PTM data reception and monitors the PDCCH addressed by at least one of a C-RNTI or a CS-RNTI on serving cells in this DRX group for reception of PTP retransmission (pertaining to PTM initial transmission)

Type 4 Active Time: MAC entity monitors a PDCCH addressed ley at least one of a C-RNTI or a CS-RNTI on serving cells in this DRX group for reception of PTP retransmission (pertaining to PTM initial transmission)

A network entity (e.g., a gNB) may configure a UE through at least one of DCI signaling or RRC signaling (e.g., an RRC reconfiguration message carries a HARQ-ReTX-Path parameter indicating either PTP or PTM) for each PTM bearer or an MBS split bearer, whether the HARQ retransmissions for the PTM initial transmission are provided by the PTP based HARQ retransmission or PTM based HARQ retransmission.

Additionally, HARQ retransmissions may be performed transparently by the network entity, i.e., a UE is not configured, and the UE is expected to monitor for both PTP based HARQ retransmissions and PTM based HARQ retransmissions. Alternatively, a HARQ-ReTX-Path parameter in the RRC reconfiguration or DCI signaling for a PTM bearer or an MBS split bearer can be absent.

Herein, a pre-defined symbol may be a first symbol after the end of a corresponding transmission carrying DL HARQ feedback.

A pre-defined symbol may be a first symbol after the end of a corresponding (virtual) transmission carrying DL HARQ feedback, in case DL HARQ feedback is not actually transmitted.

A pre-defined symbol may be a first symbol in a next slot after the end of a corresponding (virtual) transmission carrying DL HARQ feedback, in case DL HARQ feedback is not actually transmitted.

A pre-defined symbol may be a first symbol after a physical downlink shared channel (PDSCH) transmission for a corresponding HARQ process.

A pre-defined symbol may be ‘x’ symbols after a PDSCH transmission, wherein the x-value is configured by RRC signaling.

A pre-defined symbol may be:
if DL HARQ feedback (FB) is configured and/or if DL HARQ FB is enabled: the first symbol after the PDSCH transmission for the corresponding HARQ process; and
if DL HARQ FB is not configured or if DL HARQ FB is disabled: the first symbol after the PDSCH transmission for the corresponding HARQ process.

Alternatively, a pre-defined symbol may be:
if DL HARQ FB is configured and/or if DL HARQ FB is enabled: the first symbol after the PDSCH transmission for the corresponding HARQ process; and
if DL HARQ FB is not configured or if DL HARQ FB is disabled: x symbols after the PDSCH transmission. The x-value is configured by RRC signaling.

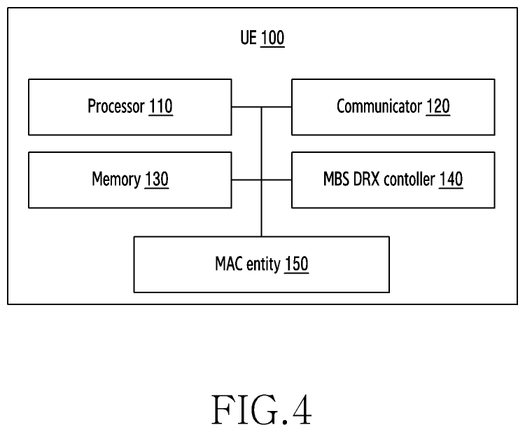

FIG. 4 illustrates a UE, according to an embodiment.

Referring to FIG. 4, the UE 100 includes a processor 110, a communicator 120, a memory 130, an MBS DRX controller 140, and a MAC entity 150. The processor 110 is coupled with the communicator 120, the memory 130, the MBS DRX controller 140, and the MAC entity 150. Additionally, an operation of the MBS DRX controller 140 and the MAC entity 150 may operate by the processor 110

The MBS DRX controller 140 detects that the DRX operation is configured for unicast and PTM, wherein a unicast DRX configuration comprises at least one of a unicast DL drx-HARQ RTT timer or a unicast DL drx-Retransmission timer, and a PTM DRX configuration comprises at least one of a PTM drx-HARQ RTT timer or a PTM drx-Retransmission timer. The MBS DRX controller 140 receives the MAC PDU in the configured DL assignment for the unicast transmission. In response to receiving the MAC PDU in the configured DL assignment, the MBS DRX controller 140 starts a unicast DL drx-HARQ RTT timer for the corresponding HARQ process in a first symbol after an end of the corresponding transmission carrying the DL HARQ feedback. Further, the MBS DRX controller 140 detects that a unicast DL drx-Retransmission timer and a PTM drx-Retransmission timer are running. Further, the MBS DRX controller 140 stops both the unicast DL drx-Retransmission timer for the corresponding HARQ process and the drx-PTM Retransmission timer for the corresponding HARQ process based on the detection.

Further, the MBS DRX controller 140 detects that the DRX group of the DRX operation is in an Active Time using the MAC entity 150. Further, the MBS DRX controller 140 monitors the PDCCH on the serving cells in the DRX group and receives the PDCCH indicating the DL transmission for unicast. Further, the MBS DRX controller 140 starts or restarts the unicast DL drx-HARQ RTT timer for the corresponding HARQ process or processes whose HARQ feedback is reported in the first symbol after the end of the corresponding transmission carrying the DL HARQ feedback. Further, the MBS DRX controller 140 detects that the unicast DL drx-Retransmission Timer and the PTM drx-Retransmission Timer are running. Further, the MBS DRX controller 140 stops both the unicast DL drx-Retransmission Timer for the corresponding HARQ process or processes whose HARQ feedback is reported and the PTM drx-Retransmission Timer for the corresponding HARQ process based on detection.

The MBS DRX controller 140 may be physically implemented by analog and/or digital circuits such as logic gates, integrated circuits, microprocessors, microcontrollers, memory circuits, passive electronic components, active electronic components, optical components, hardwired circuits, etc., or may be driven by firmware.

Further, the processor 110 is configured to execute instructions stored in the memory 130 and to perform various processes.

The communicator 120 is configured for communicating internally between internal hardware components and with external devices via one or more networks.

The memory 130 also stores instructions to be executed by the processor 110. The memory 130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. A non-transitory storage medium may store data that can, over time, change (e.g., in a random access memory (RAM) or cache).

Although the FIG. 4 illustrates various hardware components of the UE 100, it is to be understood that other embodiments are not limited thereto. For example, the UE 100 may include fewer or more components. Further, the labels or names of the components are used in FIG. 4 only for illustrative purpose and do not limit the scope of the disclosure. Further, one or more components can be combined together to perform same or substantially similar function in the UE 100.

Further description utilizes the following terminologies:

drx-HARQ-RTT-TimerDL: Represents a unicast DL DRX-HARQ RTT timer.

drx-RetransmissionTimerDL: Represents a unicast DL DRX-HARQ RTT timer.

drx-HARQ-RTT-Timer-DL-PTM: Represents a PTM drx-HARQ RTT timer.

drx-RetransmissionTimer-DL-PTM: Represents a PTM drx-retransmission timer.

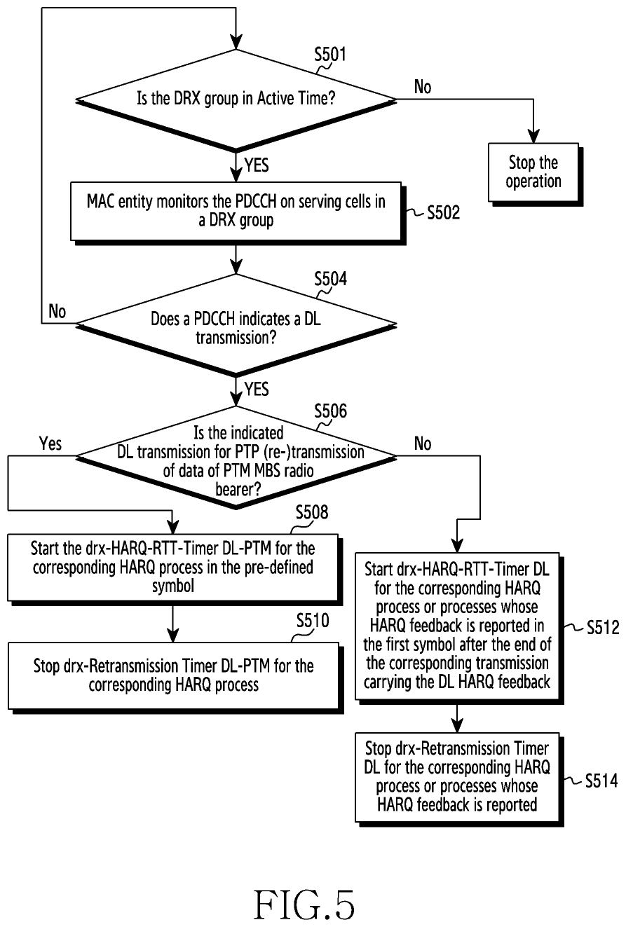

FIG. 5 is a flow chart illustrating a PDCCH monitoring and DRX timer operation, according to an embodiment. For example, the description of FIG. 5 is provided below as being performed by the UE 100 illustrated in FIG. 4.

Referring to FIG. 5, the UE 100, e.g., the MAC entity 150, monitors the PDCCH by a C-RNTI and a CS-RNTI on the serving cells. The MAC entity 150 monitors the PDCCH addressed by the C-RNTI or the CS-RNTI on the serving cells in this DRX group.

If the PDCCH indicates a DL transmission and if the DL transmission is for the PTP retransmission of data of PTM MBS radio bearer, the UE 100 starts the drx-HARQ-RTT-Timer-DL-PTM for the corresponding multicast HARQ process in the pre-defined symbol; and stops the drx-RetransmissionTimer-DL-PTM for the corresponding multicast HARQ process.

If the PDCCH indicates a DL transmission and if the DL transmission is for the PTP initial transmission or PTP retransmission of data of PTP MBS radio bearer or unicast, the UE 100 starts the drx-HARQ-RTT-TimerDL for the corresponding HARQ process or processes whose HARQ feedback is reported in the first symbol after the end of the corresponding transmission carrying the DL HARQ feedback; and stops the drx-RetransmissionTimerDL for the corresponding HARQ process or processes whose HARQ feedback is reported.

The expiration of drx-HARQ-RTT-TimerDL-PTM triggers the start of drx-RetTransmissionTimerDL-PTM when the data decoding is not successful.

That is, if a drx-HARQ-RTT-TimerDL-PTM expires:
if the data of the corresponding HARQ process was not successfully decoded:
   3> start the drx-RetransmissionTimerDL-PTM for the corresponding HARQ process in the first symbol after the expiration of drx-HARQ-RTT-TimerDL-PTM.

The expiration of drx-HARQ-RTT-TimerDL triggers the start of drx-RetransmissionTimerDL when the data decoding is not successful.

That is, if a drx-HARQ-RTT-TimerDL expires:
if the data of the corresponding HARQ process was not successfully decoded:
   start the drx-RetransmissionTimerDL for the corresponding HARQ process in the first symbol after the expiration of drx-HARQ-RTT-TimerDL.

As shown in FIG. 5, at step S501, the MAC entity 150 detects whether the DRX group of the DRX operation is in an Active Time.

If the DRX group is in Active Time, at step S502, the MAC entity 150 monitors the PDCCH on the serving cells in the DRX group.

At step S504, the MAC entity 150 determines whether the PDCCH indicates a DL transmission.

If the PDCCH indicates the DL transmission, the MAC entity 150 determines whether the indicated DL transmission for PTP (re-)transmission of data of PTM MBS radio bearer is provided at step S506.

If the indicated DL transmission for PTP (re-)transmission of data of PTM MBS radio bearer is provided at S506, the MAC entity 150 starts the drx-HARQ-RTT-TimerDL-PTM for the corresponding HARQ process in the pre-defined symbol at step S508.

At step S510, the MAC entity 150 stops drx-RetransmissionTimerDL-PTM for the corresponding HARQ process.

However, if the indicated DL transmission for PTP (re-)transmission of data of PTM MBS radio bearer is not provided at step S506, the MAC entity 150 starts the drx-HARQ-RTT-TimerDL for the corresponding HARQ process or processes whose HARQ feedback is reported in the first symbol after the end of the corresponding transmission carrying the DL HARQ feedback at step S512.

At step S514, the method includes stopping the drx-RetransmissionTimerDL for the corresponding HARQ process or processes whose HARQ feedback is reported.

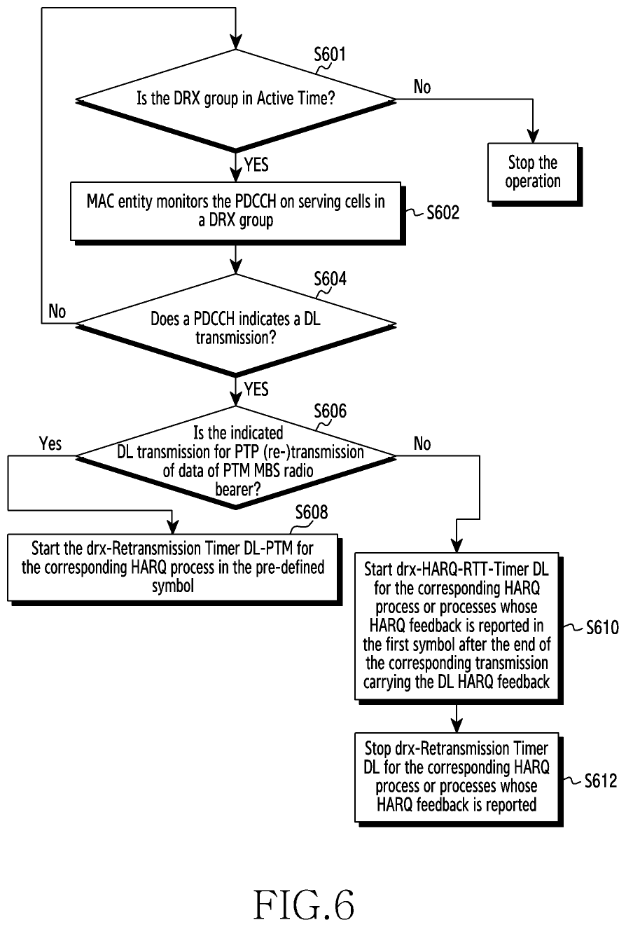

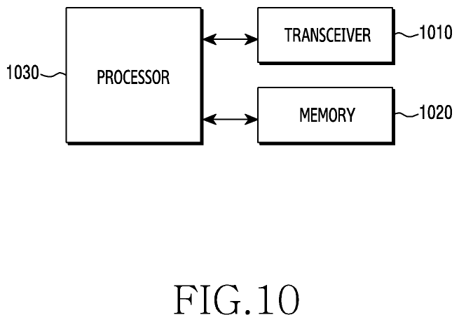

FIG. 6 is a flow chart (S600) illustrating an example scenario of PDCCH monitoring and DRX timer operation, according to the embodiments as disclosed herein. For example, the description of FIG. 6 is provided below as being performed by the UE 100 illustrated in FIG. 4 or FIG. 10.

Referring to FIG. 6, at step S601, the UE 100, e.g., the MAC entity 150, detects whether a DRX group of the DRX operation is in an Active Time.

If the DRX group is in Active Time, the MAC entity 150 monitors the PDCCH on the serving cells in the DRX group at step S602.

At step S604, the MAC entity 150 determines whether the PDCCH indicates the DL transmission.

If the PDCCH indicates the DL transmission at step S604, the MAC entity 150 determines whether the indicated DL transmission for PTP (re-)transmission of data of PTM MBS radio bearer is provided at step S606.

If indicated DL transmission for PTP (re-)transmission of data of PTM MBS radio bearer is provided at S606, the MAC entity 150 starts the drx-RetransmissionTimerDL-PTM for the corresponding HARQ process in the pre-defined symbol at step S608.

However, if indicated DL transmission for PTP (re-)transmission of data of PTM MBS radio bearer is not provided at step S606, the MAC entity 150 starts drx-HARQ-RTT-TimerDL for the corresponding HARQ process or processes whose HARQ feedback is reported in the first symbol after the end of the corresponding transmission carrying the HARQ feedback at step S610.

At step S612, the MAC entity 150 stops the drx-RetransmissionTimerDL for the corresponding HARQ process or processes whose HARQ feedback is reported.

The method of FIG. 6, as described above, illustrates a scenario of PDCCH monitoring and DRX timer operation-2.

Specifically, the MAC entity 150 monitors the PDCCH by a C-RNTI and a CS-RNTI on the serving cells in the DRX group in the Active Time. That is, the MAC entity 150 monitors the PDCCH addressed by the C-RNII or the CS-RNII on the serving cells in this DRX group.

If the PDCCH indicates a DL transmission and if the DL transmission is for the PTP retransmission of data of PTM MBS radio bearer, the MAC entity 150 starts the drx-RetransmissionTimerDL-PTM for the corresponding multicast HARQ process in the pre-defined symbol.

If the PDCCH indicates a DL transmission and if the DL transmission is for the PTP initial transmission or PTP retransmission of data of PTP MBS radio bearer or unicast, MAC entity 150 starts the drx-HARQ-RTT-TimerDL for the corresponding HARQ process or processes whose HARQ feedback is reported in the first symbol after the end of the corresponding transmission carrying the DL HARQ feedback, and stops the drx-RetransmissionTimerDL for the corresponding HARQ process or processes whose HARQ feedback is reported.

The expiration of drx-HARQ-RTT-TimerDL triggers the start of drx-RetransmissionTimerDL when the data decoding is not successful.

That is if a drx-HARQ-RTT-TimerDL expires: if the data of the corresponding HARQ process was not successfully decoded:
start the drx-RetransmissionTimerDL for the corresponding HARQ process in the first symbol after the expiration of drx-HARQ-RTT-TimerDL.

In accordance with another embodiment, an approach for DRX timer's operation is provided, wherein the MAC entity 150 monitors the GC-PDCCH addressed by a G-RNTI or a G-CS-RNTI on the serving cells in this DRX group. Further, the MAC entity 150 monitors the PDCCH addressed by a C-RNTI or a CS-RNTI on the serving cells in this DRX group.

In accordance with an embodiment, there is a HARQ retransmission configuration and the HARQ-ReTX-Path indicates PTP.

If the GC-PDCCH indicates a DL transmission and if the DL transmission is for the PTM initial transmission of data of PTM MBS radio bearer, the MAC entity 150 starts the drx-HARQ-RTT-Timer-DL for the corresponding multicast HARQ process in the pre-defined symbol; and stops the drx-RetransmissionTimer-DL for the corresponding multicast HARQ process.

If the PDCCH indicates a DL transmission and if the DL transmission is for the PTP retransmission of data of PTP MBS radio bearer, the MAC entity 150 starts the drx-HARQ-RTT-TimerDL for the corresponding HARQ process or processes whose HARQ feedback is reported in the pre-defined symbol; and stops the drx-RetransmissionTimerDL for the corresponding HARQ process or processes whose HARQ feedback is reported.

The expiration of drx-HARQ-RTT-TimerDL triggers the start of drx-RetransmissionTimerDL when the data decoding is not successful.

That is, if a drx-HARQ-RTT-TimerDL expires:
if the data of the corresponding HARQ process was not successfully decoded:
   start the drx-RetransmissionTimerDL for the corresponding HARQ process in the first symbol after the expiration of drx-HARQ-RTT-TimerDL.

In accordance with an embodiment, there is a HARQ retransmission configuration and the HARQ-ReTX-Path indicates PTM.

If the GC-PDCCH indicates a DL transmission and if the DL transmission is for the PTMinitialtransmission or PTM retransmission of data of PTM MBS radio bearer, the MAC entity 150 starts the drx-HARQ-RTT-Timer-DL-PTM for the corresponding multicast HARQ process in the pre-defined symbol; and stops the drx-RetransmissionTimer-DL-PTM for the corresponding multicast HARQ process.

The expiration of drx-HARQ-RTT-TimerDL-PTM triggers the start of drx-RetransmissionTimerDL-PTM when the data decoding is not successful.

That is, if a drx-HARQ-RTT-TimerDL-PTM expires:
if the data of the corresponding HARQ process was not successfully decoded:
   start the drx-RetransmissionTimerDL-PTM for the corresponding HARQ process in the first symbol after the expiration of drx-HARQ-RTT-TimerDL-PTM.

In according with another embodiment, there is no HARQ retransmission configuration (i.e., HARQ-ReTX-Path is not configured).

If the GC-PDCCH indicates a DL transmission and if the DL transmission is for the PTMinitialtransmission of data of PTM MBS radio bearer, the MAC entity 150 starts the drx-HARQ-RTT-Timer-DL-PTM for the corresponding multicast HARQ process in the pre-defined symbol, and stops the drx-RetransmissionTimer-DL-PTM for the corresponding multicast HARQ process; or the MAC entity 150 starts the drx-HARQ-RTT-Timer-DL for the corresponding multicast HARQ process in the pre-defined symbol, and stops the drx-RetransmissionTimer-DL for the corresponding multicast HARQ process.

If the GC-PDCCH indicates a DL transmission and if the DL transmission is for the PTM retransmission of data of PTM MBS radio bearer, the MAC entity 150 starts the drx-HARQ-RTT-Timer-DL-PTM for the corresponding multicast HARQ process in the pre-defined symbol; and stops the drx-RetransmissionTimer-DL-PTM for the corresponding multicast HARQ process.

If the PDCCH indicates a DL transmission and if the DL transmission is for the PTP retransmission of data of PTM MBS radio bearer, the MAC entity 150 Starts the drx-HARQ-RTT-Timer-DL for the corresponding multicast HARQ process in the pre-defined symbol; and stops the drx-RetransmissionTimer-DL for the corresponding multicast HARQ process.

The expiration of drx-HARQ-RTT-TimerDL-PTM triggers the start of drx-RetransmissionTimerDL-PTM when the data decoding is not successful.

That is, if a drx-HARQ-RTT-TimerDL-PTM expires:
if the data of the corresponding HARQ process was not successfully decoded:
   start the drx-RetransmissionTimerDL-PTM for the corresponding HARQ process in the first symbol after the expiration of drx-HARQ-RTT-TimerDL-PTM.

The expiration of drx-HARQ-RTT-TimerDL triggers the start of drx-RetransrissionTimerDL when the data decoding is not successful.

That is if a drx-HARQ-RTT-TimerDL expires:
if the data of the corresponding HARQ process was not successfully decoded:
   start the drx-RetransmissionTimerDL for the corresponding HARQ process in the first symbol after the expiration of drx-HARQ-RTT-TimerDL.

In accordance with another embodiment, there is no HARQ retransmission configuration (i.e., HARQ-ReTX-Path is not configured).

If the GC-PDCCH indicates a DL transmission and if the DL transmission is for the PTMinitialtransmission or PTM retransmission of data of PTM MBS radio bearer, the MAC entity 150 starts the drx-HARQ-RTT-Timer-DL-PTM for the corresponding multicast HARQ process in the pre-defined symbol; and stops the drx-RetransmissionTimer-DL-PTM for the corresponding multicast HARQ process.

If the PDCCH indicates a DL transmission and if the DL transmission is for the PTP retransmission of data of PTM MBS radio bearer, the MAC entity 150 starts the drx-HARQ-RTT-Timer-DL-PTM for the corresponding multicast HARQ process in the pre-defined symbol; and stops the drx-RetransmissionTimer-DL-PTM for the corresponding multicast HARQ process.

The expiration of drx-HARQ-RTT-TimerDL-PTM triggers the start of drx-RetransmissionTimerDL-PTM when the data decoding is not successful.

That is, if a drx-HARQ-RTT-TimerDL-PTM expires:
if the data of the corresponding HARQ process was not successfully decoded:
   start the drx-RetransmissionTimerDL-PTM for the corresponding HARQ process in the first symbol after the expiration of drx-HARQ-RTT-TimerDL-PTM.

In accordance with another embodiment, there is no HARQ retransmission configuration (i.e., HARQ-ReTX-Path is not configured).

If the GC-PDCCH indicates a DL transmission and if the DL transmission is for the PTM initial transmission or PTM retransmission of data of PTM MBS radio bearer; the MAC entity 150 Starts the drx-HARQ-RTT-Timer-DL-PTM for the corresponding multicast HARQ process in the pre-defined symbol; and stops the drx-RetTansmissionTimer-DL-PTM for the corresponding multicast HARQ process.

If the PDCCH indicates a DL transmission and if the DL transmission is for the PTP retransmission of data of PTM MBS radio bearer, the MAC entity 150 Starts the drx-HARQ-RTT-Timer-DL for the corresponding multicast HARQ process in the pre-defined symbol; and stops the drx-RetransmissionTimer-DL for the corresponding multicast HARQ process.

The expiration of drx-HARQ-RTT-TimerDL-PTM triggers the start of drx-RetransmissionTimerDL-PTM when the data decoding is not successful.

That is, if a drx-HARQ-RTT-TimerDL-PTM expires:
if the data of the corresponding HARQ process was not successfully decoded:
   start the drx-RetransmissionTimerDL-PTM for the corresponding HARQ process in the first symbol after the expiration of drx-HARQ-RTT-TimerDL-PTM.

The expiration of drx-HARQ-RTT-TimerDL triggers the start of drx-RetransmissionTimerDL when the data decoding is not successful.

That is, if a drx-HARQ-RTT-TimerDL expires:
if the data of the corresponding HARQ process was not successfully decoded:
   start the drx-RetransmissionTimerDL for the corresponding HARQ process in the first symbol after the expiration of drx-HARQ-RTT-TimerDL.

In accordance with an embodiment, the determination, configuration, or specification of the at least one predefined symbol among from the plurality of the options of the pre-defined symbol as described, may be based on at least one of whether HARQ feedback is configured, whether HARQ feedback is not configured, whether HARQ feedback is enabled, whether HARQ feedback is disabled, whether HARQ feedback is allowed to be transmitted, whether HARQ feedback is not allowed to be transmitted, whether HARQ feedback is based on ACK-NACK feedback, whether HARQ feedback is based on NACK only feedback, whether HARQ feedback is based on dedicated PUCCH resources, or whether HARQ feedback is based on common PUCCH resources. Further, a determined, configured, or specified pre-defined symbol can be utilized in combination of any of the specified embodiments as described above.

At least one of the type of Active Time among different types of Active Time can be employed in combination of any of the specified embodiments as described above.

In accordance with an embodiment, if a MAC PDU is received in a configured downlink assignment for unicast, the MAC entity 150 starts the drx-HARQ-RTT-TimerDL for the corresponding HARQ process in the first symbol after the end of the corresponding transmission carrying the DL HARQ feedback. Further, the MAC entity 150 stops the drx-RetransmissionTimerDL-PTM for the corresponding HARQ process. Further, the MAC entity 150 stops the drx-RetransmissionTimerDL for the corresponding HARQ process.

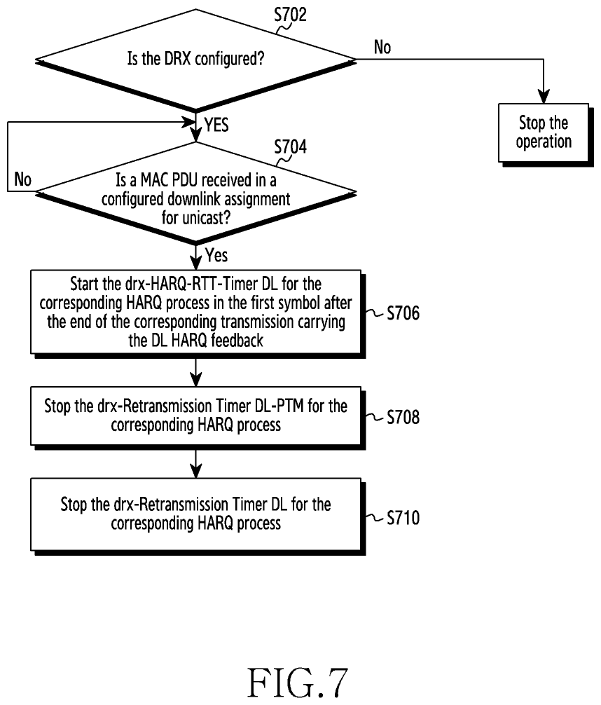

FIG. 7 is a flow chart illustrating a method for receiving a MAC PDU in a configured downlink assignment during a unicast DRX procedure, according to an embodiment. For example, the description of FIG. 7 is provided below as being performed by the UE 100 illustrated in FIG. 4 or FIG. 10.

Referring to FIG. 7, at step S702, the MAC entity 150 determines whether the DRX is configured.

If the DRX is configured at step S702, the MAC entity 150 determines whether the MAC PDU is received in a configured downlink assignment for unicast at step S704.

If the MAC PDU is received in a configured downlink assignment for unicast at S704, the MAC entity 150 starts the drx-HARQ-RTT-TimerDL for the corresponding HARQ process in the first symbol after the end of the corresponding transmission carrying the DL HARQ feedback at step S706.

At step S708, the MAC entity 150 stops the drx-RetransmissionTimerDL-PTM for the corresponding HARQ process. At step S710, the MAC entity 150 stops the drx-RetransmissionTimerDL for the corresponding HARQ process.

In accordance with an embodiment, when the DRX group is in Active Time and a PDCCH indicates downlink transmission for unicast, the MAC entity 150 starts or restarts the drx-HARQ-RTT-TimerDL for the corresponding HARQ process(es) whose HARQ feedback is reported in the first symbol after the end of the corresponding transmission carrying the DL HARQ feedback. Further, the MAC entity 150 stops the dtx-RetransmissionTimerDL-PTM for the corresponding HARQ process. Further, the MAC entity 150 stops the drx-RetransmissionTimerDL for the corresponding HARQ process(es) whose HARQ feedback is reported.

In accordance with an embodiment, the operational steps for a unicast DRX procedure are as below:

When DRX is configured, the MAC entity 150 shall:
if a MAC PDU is received in a configured downlink assignment:
   start the drx-HARQ-RTT-TimerDL for the corresponding HARQ process in the first symbol after the end of the corresponding transmission carrying the DL HARQ feedback; and

if Serving cell is configured with downlinkHARQ-FeedbackDisabled and DL HARQ feedback is disabled, dry-HARQ-RTT-TimerDL is not started for the corresponding HARQ process.

If this serving cell is part of a non-terrestrial network, the latest UE-gNB RTT value shall be used to set drx-HARQ-RTT-TimerDLanddrx-HARQ-RTT-TimerUL length prior to timer start (see TS 38.331).

stop the drx-RetransmissionTimerDL-PTM for the corresponding HARQ process;

2> stop the drx-RetransmissionTimerDL for the corresponding HARQ process. . . .

if a DRX group is in Active Time:
monitor the PDCCH on the Serving Cells in this DRX group as specified in TS 38.213;

if the PDCCH indicates a DL transmission; or

2> if the PDCCH indicates a one-shot HARQ feedback as specified in clause 9.1.4 of 3GPP TS 38.213; or

2> if the PDCCH indicates a retransmission of HARQ feedback as specified in clause 9.1.5 of TS 38.213:

start or restart the drx-HARQ-RTT-TimerDL for the corresponding HARQ process(es) whose HARQ feedback is reported in the first symbol after the end of the corresponding transmission carrying the DL HARQ feedback.

When HARQ feedback is postponed by PDSCH-to-HARQ feedback timing indicating an inapplicable k1 value, as specified in TS 38.213, the corresponding transmission opportunity to send the DL HARQ feedback is indicated in a later PDCCH requesting the HARQ-ACK feedback.

stop the drx-RetransmissionTimerDL-PTM for the corresponding HARQ process; and

stop the drx-RetransmissionTimerDL for the corresponding HARQ process(es) whose HARQ feedback is reported.

If the PDSCH-to-HARQ feedback timing indicates an inapplicable k1 value as specified in TS 38.213:

start the drx-RetransmissionTimerDL in the first symbol after the (end of the last) PDSCH transmission (within a bundle) for the corresponding HARQ process.

In accordance with another embodiment, stopping the drx-RetransmissionTimerDL-PTM may include, the following:

stop the drx-RetransmissionTimerDL-PTM, if configured and running, for the corresponding HARQ process; and

stop the drx-RetransmissionTimerDL-PTM, if configured and running, for the corresponding HARQ process(es) whose HARQ feedback is reported.

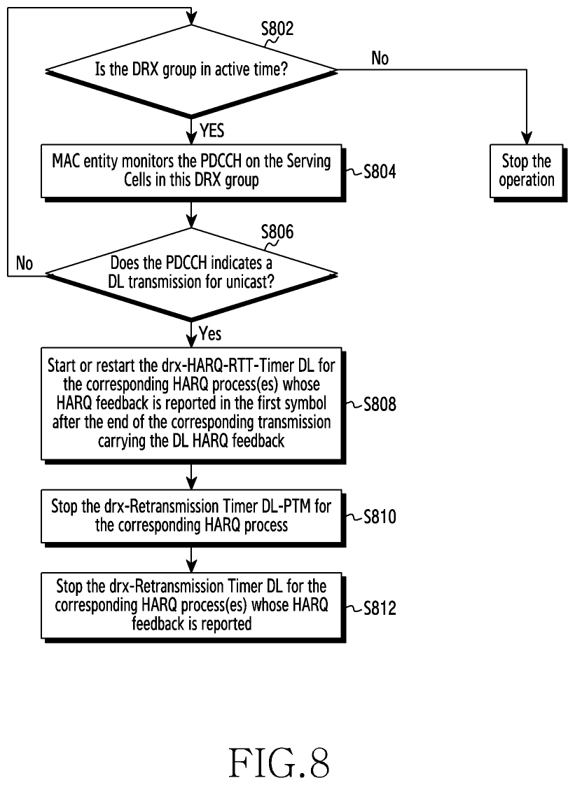

FIG. 8 is a flow chart illustrating a method for receiving a PDCCH indicating a downlink transmission during a unicast DRX procedure, according to an embodiment. For example, the description of FIG. 8 is provided below as being performed by the UE 100 illustrated in FIG. 4.

Referring to FIG. 8, at step S802, the MAC entity 150 determines that whether the DRX group is in the Active Time.

If the DRX group is in the Active Time at step S802, the MAC entity 150 monitors the PDCCH on the serving cells in the DRX group at step S804.

At step S806, the MAC entity 150 determines whether the PDCCH indicates the DL transmission for the unicast. If the PDCCH indicates the DL transmission for the unicast, the MAC entity 150 starts or restarts the drx-HARQ-RTT-TimerDL for the corresponding HARQ process(es) whose HARQ feedback is reported in the first symbol after the end of the corresponding transmission carrying the DL HARQ feedback at step S808.

At step S810, the MAC entity 150 stops the drx-RetransmissionTimerDL-PTM for the corresponding HARQ process. At step S812, the MAC entity 150 stops the drx-RetransmissionTimerDL for the corresponding HARQ process(es) whose HARQ feedback is reported.

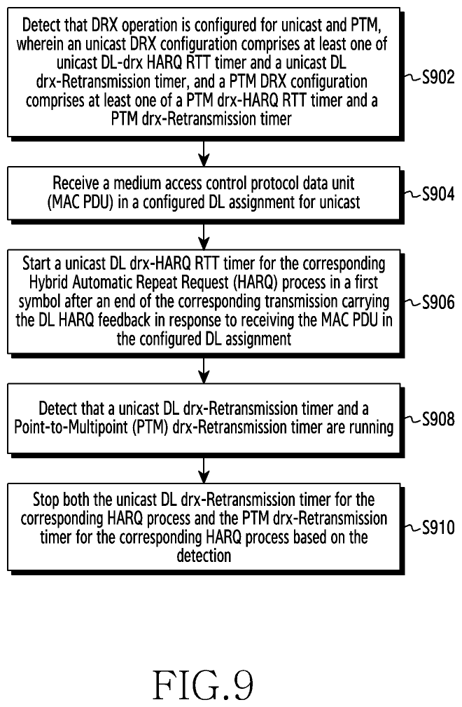

FIG. 9 is a flow chart illustrating a DRX operation for an MBS in a wireless network, according to an embodiment. For example, the description of FIG. 9 is provided below as being performed by the MBS DRX controller 140 illustrated in FIG. 4.

Referring to FIG. 9, at step S902, the MBS DRX controller 140 detects that the DRX operation is configured for unicast and PTM, wherein the unicast DRX configuration comprises at least one of the unicast DL drx-HARQ RTT timer or a unicast DL drx-Retransmission timer, and a PTM DRX configuration comprises at least one of a PTM drx-HARQ RTT timer or a PTM drx-Retransmission timer.

At step S904, the MBS DRX controller 140 receives the MAC PDU in the configured DL assignment for unicast. At step S906, the MBS DRX controller 140 starts the unicast drx-HARQ RTT timer for the corresponding HARQ process in a first symbol after an end of the corresponding transmission carrying the DL HARQ feedback in response to receiving the MAC PDU in the configured DL assignment. At step S908, the MBS DRX controller 140 detects that the unicast DL drx-Retransmission timer and a PTM drx-Retransmission timer are running.

At step S910, the MBS DRX controller 140 stops both the unicast DL drx-Retransmission timer for the corresponding HARQ process and the PTM drx-Retransmission timer for the corresponding HARQ process based on the detection.

FIG. 10 illustrates a UE, according to an embodiment.

Referring to FIG. 10, the UE includes a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those illustrated in FIG. 10.

In addition, the processor 1030, the transceiver 1010, and the memory 1020 may be implemented as a single chip. Also, the processor 1030 may include at least one processor.

The UE may correspond to RAN node 100 of FIG. 4, the processor 1030 may correspond to processor 110 of FIG. 4, the transceiver 1010 may correspond to communicator 120 of FIG. 4, and the memory 1020 may correspond to memory 130 of FIG. 4.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a radio frequency (RF) transmitter for up-converting and amplifying a frequency of a transmitted signal, and an RF receiver for amplifying low-noise and down-converting a frequency of a received signal. However, this is only an example of the transceiver 1010 and components of the transceiver 1010 are not limited to the RF transmitter and the RF receiver.

The transceiver 1010 may receive and output, to the processor 1030, a signal through a wireless channel, and transmit a signal output from the processor 1030 through the wireless channel.

The memory 1020 may store a program and data required for operations of the UE. The memory 1020 may store control information or data included in a signal obtained by the UE. The memory 1020 may be a storage medium, such as read-only memory (ROM), RAM, a hard disk, a compact disc (CD)-ROM, a digital versatile disc (DVD), or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by the base station or the network entity.

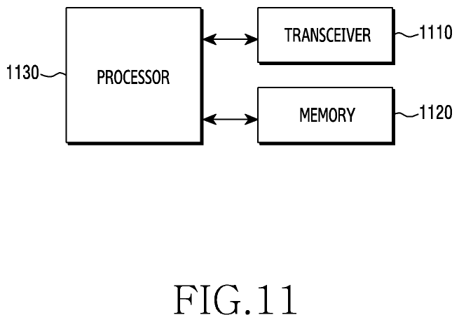

FIG. 11 illustrates a base station, according to an embodiment.

Referring to FIG. 11, the base station includes a transceiver 1110, a memory 1120, and a processor 1130. The transceiver 1110, the memory 1120, and the processor 1130 of the base station may operate according to a communication method of the base station described above. However, the components of the base station are not limited thereto. For example, the base station may include more or fewer components than those illustrated in FIG. 11.

In addition, the processor 1130, the transceiver 1110, and the memory 1120 may be implemented as a single chip. Also, the processor 1130 may include at least one processor.

The transceiver 1110 collectively refers to a base station receiver and a base station transmitter, and may transmit/receive a signal to/from a terminal or a network entity. The signal transmitted or received to or from the terminal or a network entity may include control information and data. The transceiver 1110 may include an RF transmitter for up-converting and amplifying a frequency of a transmitted signal, and an RF receiver for amplifying low-noise and down-converting a frequency of a received signal. However, this is only an example of the transceiver 1110 and components of the transceiver 1110 are not limited to the RF transmitter and the RF receiver.

The transceiver 1110 may receive and output, to the processor 1130, a signal through a wireless channel, and transmit a signal output from the processor 1130 through the wireless channel.

The memory 1120 may store a program and data required for operations of the base station. The memory 1120 may store control information or data included in a signal obtained by the base station. The memory 1120 may be a storage medium, such as ROM, RAM, a hard disk, a CD-ROM, a DVD, or a combination of storage media.

The processor 1130 may control a series of processes such that the base station operates as described above. For example, the transceiver 1110 may receive a data signal including a control signal transmitted by the terminal, and the processor 1130 may determine a result of receiving the control signal and the data signal transmitted by the terminal.

According to an embodiment, a method is provided for a DRX operation for an MBS in a wireless network. The method includes detecting, by a MAC entity of a UE in the wireless network, that a DRX operation is configured for unicast and PTM, wherein a unicast DRX configuration comprises at least one of a unicast DL drx-HARQ RTT timer and a unicast DL drx-Retransmission timer, and a PTM DRX configuration comprises at least one of a PTM drx-HARQ RTT timer and a PTM drx-Retransmission timer; receiving, by the MAC entity of the UE, a MAC PDU in a configured DL assignment for unicast; starting, by the MAC entity of the UE, the unicast DL drx-HARQ RTT timer for a corresponding HARQ process in a first symbol after an end of the corresponding transmission carrying the DL HARQ feedback in response to receiving the MAC PDU in the configured DL assignment for unicast; detecting, by the MAC entity of the UE, that the unicast DL drx-Retransmission timer and the PTM drx-Retransmission timer are running; and stopping, by the MAC entity of the UE, both the unicast DL drx-Retransmission timer for the corresponding HARQ process and the PTM drx-Retransmission timer for the corresponding HARQ process based on the detection.

According to an embodiment, a method includes detecting, by the MAC entity of the UE, that a DRX group of the DRX operation is in an Active Time; monitoring, by the MAC entity of the UE, a PDCCH on at least one serving cell in the DRX group; receiving, by MAC entity of the UE, the PDCCH indicating a DL transmission for unicast; starting or restarting, by the MAC entity of the UE, the unicast DL drx-HARQ RTT timer for the corresponding HARQ process or processes whose HARQ feedback is reported in the first symbol after the end of the corresponding transmission carrying the DL HARQ feedback in response to receiving PDCCH indicating a DL transmission for unicast; detecting, by the MAC entity of the UE, that the unicast DL drx-Retransmission Timer and the PTM drx-Retransmission Timer are running; and stopping, by the MAC entity of the UE, both the unicast DL drx-Retransmission Timer for the corresponding HARQ process or processes whose HARQ feedback is reported and the PTM drx-Retransmission Timer for the corresponding HARQ process based on the detection.

The method further includes starting, by the MAC entity of the UE, the PTM drx-Retransmission timer upon at least one of reception of PDCCH indicating a DL transmission for unicast and reception of a MAC PDU in a configured DL assignment for unicast.

The Active Time is a time period during which the MAC entity monitors a set of allocated RNTIs, wherein the Active Time comprises at least one of a first type Active Time, a second type Active Time, a third type Active Time, and a fourth type Active Time, wherein the MAC entity monitors the PDCCH addressed by at least one of C-RNTI and CS-RNTI on the serving Cells in the DRX group for unicast data reception in the first type Active Time, wherein the MAC entity monitors a GC-PDCCH addressed by at least one of a G-RNTI or a G-CS-RNTI on the serving cells in the DRX group for PTM data reception in the second type Active Time, wherein the MAC entity monitors a GC-PDCCH addressed by at least one of the G-RNTI or the G-CS-RNTI on the serving cells in the DRX group for PTM data reception and monitors the PDCCH addressed by at least one of a C-RNTI or a CS-RNII on the serving cells in the DRX group for reception of PTP retransmission for a PTM initial transmission in the third type Active Time, and wherein the MAC entity monitors the PDCCH addressed by at least one of the C-RNTI or the CS-RNTI on the serving cells in the DRX group for reception of PTP retransmission for a PTM initial transmission in the fourth type Active Time.

A HARQ retransmission for a PTM initial transmission is implicitly or explicitly provided by a PTP based HARQ retransmission or a PTM based HARQ retransmission, wherein the explicitly provided retransmission by a PTP based HARQ retransmission or a PTM based HARQ retransmission is determined by a HARQ-ReTx path parameter configured ley the wireless network to the UE, and wherein the implicitly provided retransmission implies no HARQ-ReTx path parameter is configured by the wireless network to the UE and the UE 100 monitors for both PTP based HARQ retransmission and PTM based HARQ retransmission.

A pre-defined symbol is an X^{th} symbol after an end of the corresponding transmission carrying the DL HARQ feedback in case DL HARQ feedback is not actually transmitted, is the X^{th} symbol in a slot after an end of the corresponding transmission carrying the DL HARQ feedback in case DL HARQ feedback is not actually transmitted, or is the X^{th} symbol after the PDSCH transmission for the corresponding HARQ process, wherein X is greater than or equal to 1.

The PTM drx-HARQ-RTT timer for corresponding multicast HARQ process in a pre-defined symbol is started and the PTM drx-Retransmission timer for the corresponding multicast HARQ process is stopped upon detecting a PDCCH indicates a DL transmission and the DL transmission is for the PTP retransmission of data of a PTM MBS radio bearer.

The unicast DL drx-HARQ-RTT timer for the corresponding HARQ process in the first symbol is started after the end of the corresponding transmission carrying the DL HARQ feedback and stop the unicast DL drx-Retransmission timer for the corresponding HARQ process is determined upon detecting the PDCCH indicates a DL transmission and the DL transmission is for the PTP initial transmission or PTP retransmission of data of PTP MBS radio bearer or unicast.

According to an embodiment, a UE is provided for a DRX operation for an MBS in a wireless network. The UE includes a memory; a processor; and an MBS DRX controller coupled to the memory and the processor; and: a MAC entity coupled to the MBS DRX controller, the memory, and the processor, the MAC entity being configured to detect that a DRX operation is configured for unicast and PTM, wherein a unicast DRX configuration comprises at least one of a unicast DL, drx-HARQ RTT timer or a unicast DL drx-Retransmission timer, and a PTM DRX configuration comprises at least one of a PTM drx-HARQ RTT timer or a PTM drx-Retransmission timer; receive a MAC PDU in a configured DL assignment for unicast; start the unicast DL drx-HARQ RTT timer for a corresponding HARQ process in a first symbol after an end of the corresponding transmission carrying the DL HARQ feedback in response to receiving the MAC PDU in the configured DL assignment for unicast; detect that the unicast DL drx-Retransmission timer and the PTM drx-Retransmission timer are running; and stop both the unicast DL drx-Retransmission timer for the corresponding HARQ process and the PTM drx-Retransmission timer for the corresponding HARQ process based on the detection.

The MAC entity is further configured to detect that a DRX group of the DRX operation is in an Active Time; monitor a PDCCH on the serving cells in the DRX group; receive the PDCCH indicating a DL transmission for unicast; start or restart the unicast DL drx-HARQ RTT timer for the corresponding HARQ process or processes whose HARQ feedback is reported in the first symbol after the end of the corresponding transmission carrying the DL HARQ feedback; detect that the unicast DL drx-Retransmission Timer and the PTM drx-Retransmission Timer are running; and stop both the unicast DL drx-Retransmission Timer for the corresponding HARQ process or processes whose HARQ feedback is reported and the PTM drx-Retransmission Timer for the corresponding HARQ process.

The MAC entity is further configured to start the PTM drx-Retransmission timer upon at least one of reception of PDCCH indicating a DL transmission for unicast and reception of a MAC PDU in a configured DL assignment for unicast.

In The Active Time is a time period during which the MAC entity monitors a set of allocated RNTIs, wherein the Active Time comprises at least one of a first type Active Time, a second type Active Time, a third type Active Time, and a fourth type Active Time, wherein the MAC entity monitors the PDCCH addressed by at least one of a C-RNTI or a CS-RNTI on the serving cells in the DRX group for unicast data reception in the first type Active Time, wherein the MAC entity monitors a GC-PDCCH addressed by at least one of a G-RNTI or a G-CS-RNTI the serving cells in the DRX group for PTM data reception in the second type Active Time, wherein the MAC entity 150 monitors a GC-PDCCH addressed by at least one of a G-RNTI or a G-CS-RNTI on the serving cells in the DRX group for PTM data reception and monitors the PDCCH addressed by at least one of a C-RNTI or a CS-RNTI on the serving cells in the DRX group for reception of PTP retransmission for a PTM initial transmission in the third type Active Time, and wherein the MAC entity monitors the PDCCH addressed by at least one of a C-RNTI or a CS-RNTI on the serving cells in the DRX group for reception of PTP retransmission for a PTM initial transmission in the fourth type Active Time.

A HARQ retransmission for a PTM initial transmission is provided implicitly or explicitly by a PTP based HARQ retransmission or a PTM based HARQ retransmission, wherein the explicitly provided retransmission by a PTP based HARQ retransmission or a PTM based HARQ retransmission is determined by a HARQ-ReTx path parameter configured by the wireless network to the UE, and wherein the implicitly provided retransmission implies no HARQ-ReTx path parameter is configured by the wireless network to the UE 100 and the UE 100 monitors for both PTP based HARQ retransmission and PTM based HARQ retransmission.

A pre-defined symbol is an X^{th} symbol after an end of the corresponding transmission carrying the DL HARQ feedback in case DL HARQ feedback is not actually transmitted, is the X^{th} symbol in a slot after an end of the corresponding transmission carrying the DL HARQ feedback in case DL HARQ feedback is not actually transmitted, or is the X^{th} symbol after the PDSCH transmission for the corresponding HARQ process, wherein X is greater than or equal to 1.

In The PTM drx-HARQ-RTT timer for a corresponding multicast HARQ process in a pre-defined symbol is started and the PTM drx-Retransmission timer for the corresponding multicast HARQ process is stopped upon detecting a PDCCH indicates a DL transmission and the DL transmission is for the PTP retransmission of data of a PTM MBS radio bearer.

The unicast DL drx-HARQ RTT timer for the corresponding HARQ process in the first symbol is started after the end of the corresponding transmission carrying the DL HARQ feedback and stop the unicast DL drx-Retransmission timer for the corresponding HARQ process is determined upon detecting the PDCCH indicates a DL transmission and the DL transmission is for the PTP initial transmission or PTP retransmission of data of PTP MBS radio bearer or unicast.

Accordingly, an embodiment herein provides a method for discontinuous reception (DRX) operation for Multicast Broadcast Service (MBS) in a wireless network. The method includes detecting, by a Medium Access Control (MAC) entity of a UE in the wireless network, that a DRX operation is configured for unicast and Point-to-Multipoint (PTM), wherein an unicast DRX configuration comprises at least one of a unicast DL drx-HARQ Round Trip Time (RTT) timer and a unicast DL drx-Retransmission timer, and a PTM DRX configuration comprises at least one of a PTM drx-HARQ Round Trip Time (RTT) timer and a PTM drx-Retransmission timer. Further, the method includes receiving, by the MAC entity of the UE, a medium access control protocol data unit (MAC PDU) in a configured downlink (DL) assignment for unicast. Further, the method includes starting, by the MAC entity of the UE, the unicast DL drx-HARQ Round Trip Time (RTT) timer for the corresponding Hybrid Automatic Repeat Request (HARQ) process in the first symbol after an end of the corresponding transmission carrying the DL HARQ feedback in response to receiving the MAC PDU in the configured DL assignment for unicast. Further, the method includes detecting, by the MAC entity of the UE, that the unicast DL drx-Retransmission timer and the Point-to-Multipoint (PTM) drx-Retransmission timer are running. Further, the method includes stopping, by the MAC entity of the UE, both the unicast DL drx-Retransmission timer for the corresponding HARQ process and the PTM drx-Retransmission timer for the corresponding HARQ process based on the detection.

In an embodiment, the method includes detecting, by the MAC entity of the UE, that a DRX group of the DRX operation is in an Active Time. Further, the method includes monitoring, by the MAC entity of the UE, a Physical Downlink Control Channel (PDCCH) on the serving cells in the DRX group. Further, the method includes receiving, by MAC entity of the UE, the PDCCH indicating a DL transmission for unicast. Further, the method includes starting or restarting, by the MAC entity of the UE, the unicast DL drx-HARQ RTT timer for the corresponding HARQ process or processes whose HARQ feedback is reported in the first symbol after the end of the corresponding transmission carrying the DL HARQ feedback in response to receiving PDCCH indicating a DL transmission for unicast. Further, the method includes detecting, by the MAC entity of the UE, that the unicast DL drx-Retransmission Timer and the PTM drx-Retransmission Timer are running. Further, the method includes stopping, by the MAC entity of the UE, both the unicast DL drx-Retransmission Timer for the corresponding HARQ process or processes whose HARQ feedback is reported and the PTM drx-Retransmission Timer for the corresponding HARQ process based on the detection.

In an embodiment, the PTM drx-Retransmission timer is started upon at least one of reception of PDCCH indicating a DL transmission for unicast and reception of a MAC PDU in a configured DL assignment for unicast.

In an embodiment, the Active Time is a time period during which the MAC entity monitors a set of allocated Radio Network Temporary Identifiers (RNTIs), wherein the Active Time comprises at least one of a first type Active Time, a second type Active Time, a third type Active Time and a fourth type Active Time, wherein the MAC entity monitors the PDCCH addressed by at least one of C-RNTI and CS-RNTI on the serving cells in the DRX group for unicast data reception in the first type Active Time, wherein the MAC entity monitors a GC-PDCCH addressed by at least one of G-INTI and G-CS-RNTI on the serving cells in the DRX group for PTM data reception in the second type Active Time, wherein the MAC entity monitors a GC-PDCCH addressed by at least one of G-RNTI and G-CS-INTI on the serving cells in the DRX group for PTM data reception and monitors the PDCCH addressed by at least one of C-RNTI and CS-RNTI on the serving cells in the DRX group for reception of PTP retransmission for a PTM initial transmission in the third type Active Time, and wherein the MAC entity monitors the PDCCH addressed by at least one of C-RNTI and CS-RNTI on the serving cells in the DRX group for reception of PTP retransmission for a PTM initial transmission in the fourth type Active Time.

In an embodiment, a HARQ retransmission for a PTM initial transmission is implicitly or explicitly provided by a PTP based HARQ retransmission or a PTM based HARQ retransmission, wherein explicitly provided retransmission by a PTP based HARQ retransmission or a PTM based HARQ retransmission is determined by a HARQ-ReTx path parameter configured by network to UE and wherein implicitly provided retransmission implies no HARQ-ReTx path parameter is configured by network to UE and UE monitors for both PTP based HARQ retransmission and PTM based HARQ retransmission.

In an embodiment, a pre-defined symbol is the symbol (e.g., first symbol or any symbol or X^{th} symbol, where X>=1) after an end of the corresponding (virtual) transmission carrying the DL HARQ feedback in case DL HARQ feedback is not actually transmitted, wherein a pre-defined symbol is the symbol (e.g., first symbol or any symbol or X^{th} symbol, where X>=1) in a slot after an end of the corresponding (virtual) transmission carrying the DL HARQ feedback in case DL HARQ feedback is not actually transmitted, wherein a pre-defined symbol is the symbol (e.g., first symbol or any symbol or X^{th} symbol, where X>=1) after the PDSCH transmission for the corresponding HARQ process.

In an embodiment, the PTM drx-HARQ RTT timer for corresponding multicast HARQ process in a pre-defined symbol is started and the PTM drx-Retransmission timer for the corresponding multicast HARQ process is stopped upon detecting a PDCCH indicates a DL transmission and the DL transmission is for the PTP retransmission of data of a PTM MBS radio bearer.

In an embodiment, the unicast DL drx-HARQ-RTT timer for the corresponding HARQ process in the first symbol is started after the end of the corresponding transmission carrying the DL HARQ feedback and stop the unicast DL drx-Retransmission timer for the corresponding HARQ process is determined upon detecting the PDCCH indicates a DL transmission and the DL transmission is for the PTP initial transmission or PTP retransmission of data of PTP MBS radio bearer or unicast.

Accordingly, an embodiment herein provides a UE for DRX operation for MBS in a wireless network. The method includes an MBS DRX controller coupled to a memory and a processor, and a MAC entity coupled to the MBS DRX controller, the memory and the processor. The MAC entity detects that a DRX operation is configured for unicast and Point-to-Multipoint (PTM), wherein a unicast DRX configuration comprises at least one of a unicast DL drx-HARQ Round Trip Time (RTT) timer and a unicast DL drx-Retransmission timer, and a PTM DRX configuration comprises at least one of a PTM drx-HARQ Round Trip Time (RTT) timer and a PTM drx-Retransmission timer. Further, the MAC entity receives a medium access control protocol data unit (MAC PDU) in a configured downlink (DL) assignment for unicast. Further, the MAC entity starts the unicast DL drx-HARQ RTT timer for the corresponding Hybrid Automatic Repeat Request (HARQ) process in a first symbol after an end of the corresponding transmission carrying the DL HARQ feedback in response to receiving the MAC PDU in the configured DL assignment for unicast. Further, the MAC entity detects that the unicast DL drx-Retransmission timer and the PTM drx-Retransmission timer are running. Further, the MAC entity stops both the unicast DL dry-Retransmission timer for the corresponding HARQ process and the PTM drx-Retransmission timer for the corresponding HARQ process based on the detection.

Accordingly, an embodiment herein provides a UE for DRX operation for MBS in a wireless network. The UE includes an MBS DRX controller coupled to a memory and a processor, and a MAC entity coupled to the MBS DRX controller the memory and the processor. The MAC entity detects that a DRX group of the DRX operation is in an Active Time. Further, the MAC entity monitors a Physical Downlink Control Channel (PDCCH) on the serving cells in the DRX group. Further, the MAC entity receives the PDCCH indicating a DL transmission for unicast. Further, the MAC entity starts or restarts the unicast DL drx-HARQ RTT timer for the corresponding HARQ process or processes whose HARQ feedback is reported in the first symbol after the end of the corresponding transmission carrying the DL HARQ feedback. Further, the MAC entity detects that the unicast DL drx-Retransmission Timer and the PTM drx-Retransmission Timer are running. Further, the MAC entity stops both the unicast DL drx-Retransmission Timer for the corresponding HARQ process or processes whose HARQ feedback is reported and the PTM drx-Retransmission Timer for the corresponding HARQ process.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

The various actions, acts, blocks, steps, or the like in the flow charts of FIGS. 5 to 9 may be performed in the order presented, in a different order or simultaneously. Further, in some embodiments, some of the actions, acts, blocks, steps, etc., may be omitted, added, modified, skipped, etc., without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A method performed by a terminal in a wireless communication system, the method comprising:
receiving a medium access control (MAC) protocol data unit (PDU) for a unicast;
starting a hybrid automatic repeat request (HARQ) round trip time (RTT) timer for the unicast in a first symbol after an end of a transmission carrying a HARQ feedback for a HARQ process corresponding to a downlink (DL) assignment;
stopping a retransmission timer for the unicast for the HARQ process corresponding to the DL assignment; and
stopping a retransmission timer for a multicast for the HARQ process corresponding to the DL assignment.

2. The method of claim 1, further comprising:
identifying an expiration of the HARQ RTT timer for the unicast;
determining whether data decoding of the HARQ process is successful; and
starting the retransmission timer of the unicast after the expiration of the HARQ RTT timer for the unicast, in case that the data decoding is not successful.

3. The method of claim 1, wherein the retransmission timer for the multicast is used for a multicast and broadcast service (MBS).

4. The method of claim 1, further comprising:
identifying an expiration of a HARQ RTT timer for the multicast;
determining whether data decoding of the HARQ process is successful; and
starting the retransmission timer of the multicast after the expiration of the HARQ RTT timer for the multicast, in case that the data decoding is not successful.

5. The method of claim 4, wherein the HARQ RTT timer for the multicast is operated based on a drx-HARQ-RTT-TimerDL-PTM parameter and the retransmission timer for the multicast is operated based on a drx-RetransmissionTimerDL-PTM parameter.

6. The method of claim 5, wherein the dry-HARQ-RTT-TimerDL-PTM parameter and the drx-RetransmissionTimerDL-PTM parameter are configured by radio resource control (RRC) signaling.

7. The method of claim 1, further comprising:
monitoring a physical downlink control channel (PDCCH) when a discontinuous reception (DRX) group of the terminal is in an active time;
detecting downlink control information (DCI) on the PDCCH;
in case that the DCI indicates a DL transmission for the unicast, starting or restarting the HARQ RTT timer for the unicast in the first symbol after the end of the transmission carrying the HARQ feedback for the HARQ process corresponding to the DL assignment.
stopping the retransmission timer for the unicast for the HARQ process corresponding to the DL assignment; and
stopping the retransmission timer for the multicast for the HARQ process corresponding to the DL assignment.

8. The method of claim 7, wherein monitoring the PDCCH comprises monitoring the PDCCH using at least one of a group radio network temporary identifier (G-RNTI), a group configured scheduling RNTI (G-CS-RNTI), a cell RNTI (C-RNTI), or a configured scheduling RNTI (CS-RNTI).

9. The method of claim 1, wherein the HARQ RTT timer for the unicast is operated based on a drx-HARQ-RTT-TimerDL parameter and the retransmission timer for the unicast is operated based on a drx-RetransmissionTimerDL parameter.

10. The method of claim 9, wherein the drx-HARQ-RTT-TimerDL parameter and the drx-RetransmissionTimerDL parameter are configured by radio resource control (RRC) signaling.

11. A terminal in a wireless communication system, the terminal comprising:
a transceiver; and
a processor coupled with the transceiver and configured to:
receive a medium access control (MAC) protocol data unit (PDU) for a unicast,
start a hybrid automatic repeat request (HARQ) round trip time (RTT) timer for the unicast in a first symbol after an end of a transmission carrying a HARQ feedback for a HARQ process corresponding to a downlink (DL) assignment,
stop a retransmission timer for the unicast for the HARQ process corresponding to the DL assignment, and
stop a retransmission timer for a multicast for the HARQ process corresponding to the DL assignment.

12. The terminal of claim 11, wherein the processor is further configured to:
identify an expiration of the HARQ RTT timer for the unicast,
determine whether data decoding of the HARQ process successful, and
start the retransmission timer of the unicast after the expiration of the HARQ RTT timer for the unicast, in case that the data decoding is not successful.

13. The terminal of claim 11, wherein the retransmission timer for the multicast is used for a multicast and broadcast service (MBS).

14. The terminal of claim 11, wherein the processor is further configured to:
identify an expiration of a HARQ RTT timer for the multicast,
determine whether data decoding of the HARQ process successful, and
start the retransmission timer of the multicast after the expiration of the HARQ RTT timer for the multicast, in case that the data decoding is not successful.

15. The terminal of claim 14, wherein the HARQ RTT timer for the multicast is operated based on a drx-HARQ-RTT-TimerDL-PTM parameter and the retransmission timer for the multicast is operated based on a drx-RetransmissionTimerDL-PTM parameter.

16. The terminal of claim 15, wherein the drx-HARQ-RTT-TimerDL-PTM parameter and the drx-RetransmissionTimerDL-PTM parameter are configured by radio resource control (RRC) signaling.

17. The terminal of claim 11, wherein the processor is further configured to:
monitor a physical downlink control channel (PDCCH) when a discontinuous reception (DRX) group of the terminal is in an active time,
detect downlink control information (DCI) on the PDCCH,
in case that the DCI indicates a DL transmission for the unicast, start or restart the HARQ RTT timer for unicast in the first symbol after the end of the transmission carrying the HARQ feedback for the HARQ process corresponding to the DL assignment.
stop the retransmission timer for the unicast for the HARQ process corresponding to the DL assignment; and
stop the retransmission timer for the multicast for the HARQ process corresponding to the DL assignment.

18. The terminal of claim 17, wherein the processor is further configured to monitor the PDCCH using at least one of a group radio network temporary identifier (G-RNTI), a group configured scheduling RNTI (G-CS-RNTI), a cell RNTI (C-RNTI), or a configured scheduling RNTI (CS-RNTI).

19. The terminal of claim 11, wherein the HARQ RTT timer for the unicast is operated based on a drx-HARQ-RTT-TimerDL parameter and the retransmission timer for the unicast is operated based on a drx-RetransmissionTimerDL parameter.

20. The terminal of claim 19, wherein the drx-HARQ-RTT-TimerDL parameter and the drx-RetransmissionTimerDL parameter are configured by radio resource control (RRC) signaling.
